(19) United States
(12) Patent Application Publication
(10) Pub. No.: US 2006/0290963 A1
(43) Pub. Date: Dec. 28, 2006

(54) Image forming apparatus and image operating apparatus

(76) Inventors: Tamotsu Sakuraba, Tokyo (JP); Toshimi Shinchi, Tokyo (JP)

Correspondence Address: CANTOR COLBURN, LLP, 55 GRIFFIN ROAD SOUTH, BLOOMFIELD, CT, 06002, US

(21) Appl. No.: 11/231,409

(22) Filed: Sep. 21, 2005

(30) Foreign Application Priority Data
Jun. 27, 2005 (JP) 2005-186601

(51) Int. Cl. G06F 3/12

(52) U.S. Cl. 358/1.13; 358/1.15

(57) ABSTRACT

Disclosed is an image forming apparatus including: a receiving unit to receive PDL data, an image manipulating unit to create bitmap data according to the PDL data, a memory unit to store the bitmap data, and when the PDL data contains a first password, a control unit to create a restriction information for the reuse of the bitmap data by referring to the first password and associates the restriction information with the bitmap data.

### BACKGROUND OF THE INVENTION

1. Field of the Invention

The present invention relates to an image forming apparatus and an image operating apparatus to operate the image data.

2. Description of the Related Art

Generally, as a function to keep the confidentiality of a document file made by PC (Personal Computer) and the like, functions such as a function that prohibits opening the file without password entry, typically known as PDF(Portable Document Format), and security print function when sending print job by printer driver are used. In addition, JP2004-152108 discloses a function that determines the availability of printing the job for each print request and a function that sets a limitation on the output device.

However, within the above mentioned earlier development, when prepared documents are printed through printer control unit, bitmap form of the image data (bitmap data) is stored in the printer control unit and would be able to observe or modify these data by job spooler utility or the like, it was difficult to maintain the confidentiality. Similarly, confidentiality was not assured when converting the bitmap data to other forms of data.

### SUMMARY

The present invention has been made to solve the above problems. An object of the invention is to maintain the confidentiality in case bitmap data, made when printing was outputted, is reused.

The image forming apparatus according to an embodiment reflecting one aspect of the invention comprises:

a reception unit to receives PDL data;

an image operating unit to create bitmap data based on the PDL data;

a memory unit to store the bitmap data; and a control unit to create restriction information for reuse of the bitmap data, and to associate the restriction information with the bitmap data in reference to a first password, when the PDL data contains a first password.

Preferably, the image processing unit includes a hardware utilizing exclusive operation circuit, or includes a general operation circuit collaborating with software, such as central processing circuit. The memory unit includes any device capable of holding the bitmap data in a reusable manner. Preferably, the memory unit comprises a nonvolatile memory device that can hold the bitmap data in a reusable manner even while the image forming apparatus such as a hard disc is de-energized. The control unit includes a hardware utilizing exclusive operation circuit, or includes a general operation circuit collaborating with software, such as central processing circuit. Additionally, when the image processing unit and the control unit utilize general operation circuit, the same general operation circuit can be used for both units.

Further, the control unit preferably stores the restriction information with association to the bitmap data in the memory unit.

Additionally, the restriction information may be a second password, made from the first password.

Preferably, the control unit applies the identical password to the first password as the second password.

Further, by referring to the restriction information, the control unit may determine whether to authorize the reuse of the bitmap data by an operator.

Additionally, the control unit may, with an operation unit to receive input from the operator, verify the inputted information with the restriction information, then determine whether to authorize the reuse of the bitmap data.

The image operating apparatus according to another embodiment reflecting another aspect of the invention for reusing the bitmap data created when the printing requiring a first password was outputted, the image operating apparatus comprises:

an operation unit to receive input from the operator;

a control unit that determines whether to authorize reuse of the bitmap data by the operator, by verifying the information input from the operation unit with the restriction information concerning the reuse of the bitmap data made in reference to the first password.

The control unit includes a hardware utilizing exclusive operation circuit, or includes a general operation circuit collaborating with software, such as central processing circuit.

The restriction information may be the second password, made referring to the first password.

Preferably, the control unit applies the identical password to the first password as the second password.

Additionally, the control unit, after determination to authorize the operator the reuse of the bitmap data, sends information that promotes a selection on whether or not apply the restriction information to the data file after processing.

Further, it is preferable that the control unit is provided a display unit to display various kinds of information, and makes the display unit display the information that promotes the selection.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing a schematic structure illustrating a printing system according to one embodiment of the invention;

FIG. 2 is a block diagram showing a structure of a main part of a client PC;

FIG. 3 is a block diagram showing a structure of a main part of a printer control unit;

FIG. 4 is a block diagram showing a structure of a main part of a printer;

FIG. 5 is a flow chart showing steps executed within the client PC when printing is requested;

FIG. 6 is a flow chart showing steps executed within the printer control unit when printing is performed;

FIG. 7 is a view showing a schematic structure of bitmap data, stored in a hard disc provided in the printer control unit;

FIG. 8 is a flow chart showing executed steps within the printer when printing is performed;

FIG. 9 is a flow chart showing executed steps concerning reuse of the bitmap data within the printer control unit;

FIG. 10 is a view showing one example of a list of printed print job, displayed on a display unit of the printer control unit; and

FIG. 11 is a view showing one example of a dialog for setting a user administration, displayed on a display unit of the printer control unit.

### DETAILED DESCRIPTION OF THE PREFERRED EMBODIMENTS

An embodiment of the present invention will be described below with reference to respective figures.

First of all, description on the structure of the present embodiment will be explained.

FIG. 1 is a view showing an entire structure of a print system 10 according to one embodiment of the invention. As shown in FIG. 1, print system 10 comprises a client PC (Personal Computer) 1, a printer control unit 2, and a printer 3, that are connected by a communication network N, capable of mutual communication.

Communication network N comprises LAN (Local Area Network) that connects computers and network devices and the like through a standard such as Ethernet (registered trademark), token ring, FDDI (Fiber Distributed Data Interface) and the like, or of WAN (Wide Area Network) which is made by connecting LAN with leased circuit, or the like.

Meantime, the numbers of devices comprising the print system 10, that is, client PC 1, printer control unit 2, and printer 3, is not limited. Additionally, FIG. 1 shows a view with printer control unit 2 and printer 3 connected by communication network N, however, the embodiment is not limited to this structure. For example, interface such as IEEE1394 can be used.

Additionally, FIG. 1 shows a view where printer control unit 2 and printer 3 is a distinct unit, however, an image forming apparatus with a chassis, provided both function in one chassis, can be used. Further, instead of printer 3, an image forming apparatus such as MFP (Multi Function Peripheral), with multiple function such as copying machine, scanner, printer and the like, can be used.

Print job (created by printer driver according to various data such as document data made by various application software, ledger sheet data from the routine task, and image data made by image processing software.) made by client PC 1 is sent to printer control unit 2. Printer control unit 2 converts the print job sent from client PC 1 into an image data (bitmap data) for printer 3 to form image.

Next, description on the structure of client PC 1, printer control unit 2, and printer 3 will be explained, however, for portions of the unit with similar function, description will be given only one time to avoid description duplication, and will be omitted from then on.

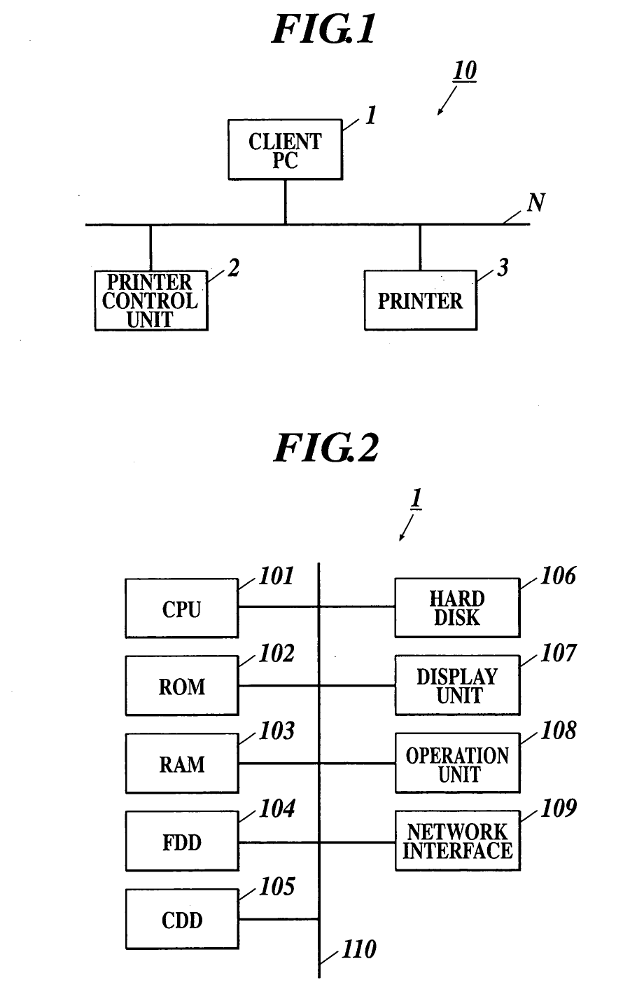

FIG. 2 shows the main structure of client PC 1. Client PC 1 is a general personal computer, and, as shown in FIG. 2, comprises a CPU (Central Processing Unit) 101 for operating the entire client PC 1, a ROM (Read Only Memory) 102 for storing various programs and data, a RAM (Random Access Memory) 103 for temporally memorizing programs and data as a work area, an FDD (Flexible Disc Drive) 104 for reading a flexible disc which is not described, a CDD (Compact Disc Drive) 105 for reading a CD-ROM which is not described, a hard disk 106 for storing programs that CPU operates and data, a display unit 107 such as liquid crystal display for displaying various information, an operation unit 108 comprising of keyboard and mouse and the like for inputting various instructions, and a network interface 109 such as LAN card for communicating with communication network N, that are mutually connected through bus 110 for exchanging signals.

When CPU 101 is requested to print the prepared document by operation unit 108, it converts the data from an application file format into a PDL (Page Description Language) file format (PDL data). In particular, when security printing is requested, CPU stores the first password inputted from operation unit 108 as security printing information in the PDL data.

A hard disk 106 is capable of storing printer driver for controlling printer and applications for transmitting data. At this point, printer driver stored in the hard disk 106 is software for controlling the printer, capable of creating print job with CPU 101 by converting data on letters and images received from the application, into PDL data that printer can recognize. In addition, printer driver has functions such as layout function for reducing the plurality of pages to be printed in one page, alarming function for observing the status of the printer and warning that the printer is out of paper or toner, or the like.

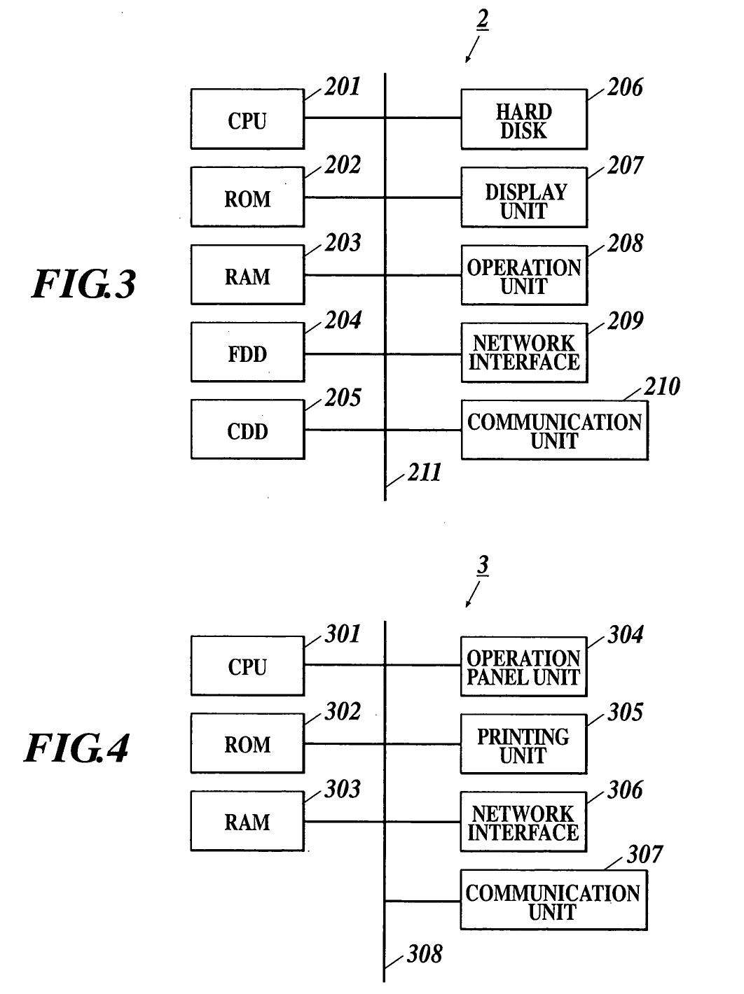

FIG. 3 shows the main structure of printer control unit 2. Printer control unit 2 is a server computer for the printer, and as shown in FIG. 3, comprises CPU 201, ROM 202, RAM 203, FDD 204, CDD 205, hard disk 206, display unit 207, operation unit 208, network interface 209, and communication unit 210, and are mutually connected through bus 210 for exchanging signals.

CPU 201 converts the PDL data obtained from client PC 1 into bitmap data and stores it in the hard disk 206. In particular, when PDL data contains security printing information, CPU 201 creates restriction information (second password) concerning reuse of bitmap data, and stores this restriction information associated with the bitmap data in the hard disk 206. In this embodiment, the primary password and the secondary password are the same.

Additionally, when it is requested to reuse the bitmap data stored in the hard disk 206, CPU 201 verifies the corresponding restriction information concerning the reuse of the bitmap data stored in the with the password entered from the operation unit 208, and determines whether reuse of the bitmap data is authorized.

Within the hard disk 206, application for exchanging data, program for converting PDL data of the print job obtained from the external client PC 1 into bitmap data, and the like are stored. Additionally, bitmap data and restriction information concerning the reuse of such bitmap data are stored with association.

The communication unit 210, for example, comprises interface IEEE1394 serial bus and its control unit, and exchanges various data through the IEEE1394 serial bus.

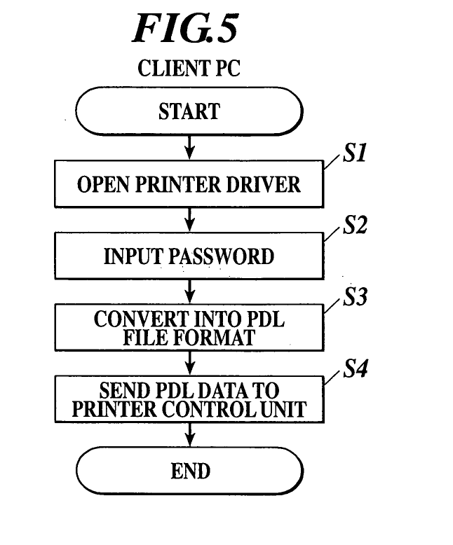

FIG. 4 shows the main structure of printer 3. Printer 3, according to the request from the printer control unit 2, prints the bitmap data created by printer control unit 2 on the paper sheet. As shown in FIG. 4, printer 3 comprises CPU 301, ROM 302, RAM 303, operation panel unit 304, printing unit 305, network interface 306, and communication unit 307, that are connected with each other by bus 308 through which signals are exchanged.

When CPU 301 receives request for security printing from the printer control unit 2, it displays a password input dialog on the operation panel unit 304 and promotes to enter the password. If the correct password is entered, CPU 301 requests printing unit 305 to perform printing.

Operation panel unit 304, which is used to display various information and to input various requests, is installed so as to cover the display function such as LCD (Liquid Crystal Display), detects the coordinates by coordinate reading principles such as electromagnetic guidance, magnetostriction, pressure sensing, or the like, and outputs detected coordinates as a position signal to CPU 301.

Printing unit 305, according to the printing control signals from CPU 301, prints the image data on the paper sheet by predetermined printing method (such as laser-beam method).

Client PC 1, printer control unit 2, and printer 3 may have additional components other than the components mentioned above, or may lack the components mentioned above in part.

Next is described the processing of this embodiment.

First, the processing conducted at client PC 1 when printing is requested, is described referring to the flowchart FIG. 5.

When performing security printing of a document created by the application installed in the client PC 1, the printer driver is opened (step S1), and then GUI (Graphical User Interface) display of the printer driver is displayed on the display unit 107. This GUI display contains password input dialog necessary for security printing.

When the password (first password) is entered in the GUI display by an operator (step S2), the application form data is converted into PDL file form data (PDL data) (step S3). The password entered in step S2 is stored in the PDL data when conversion into PDL data form is conducted.

In the PDL data, specifically, request for security printing and the password are set as below. The below example is the case when security printing is requested and the password is “private”.

SECURITY=ON

PASSWORD=private

PDL data containing information on presence of request for security printing and password is sent to the printer control unit 2 through the communication network N (step S4), and the processing at client PC 1 is completed.

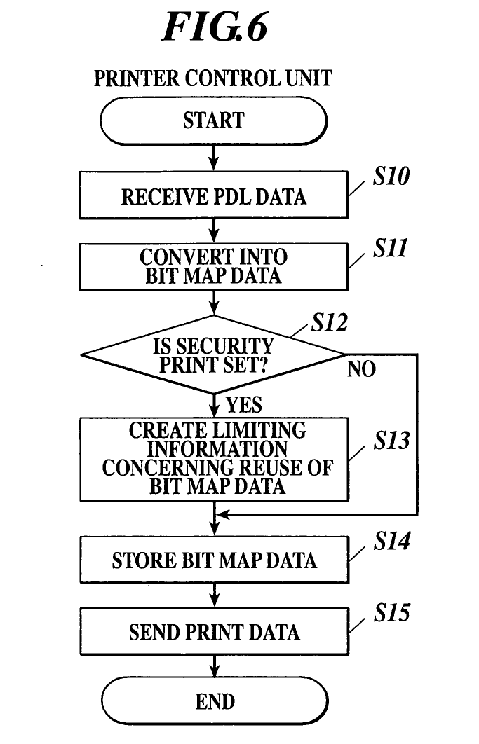

Next, the processing conducted at printer control unit 2, which receives the PDL data is described referring to the flowchart FIG. 6.

When printer control unit 2 receives PDL data from client PC 1 (step S10), the PDL data is converted into a bitmap data (step S11). Then, from the PDL data containing information on presence of request for security printing, determination on whether security printing is set or not is made (step S12).

When it is determined that security printing is set (step S12; YES), restriction information for the reuse of bitmap data (second password) is created from the first password contained in the PDL data (step S13). Then the information on presence of request for security print, restriction information, and the bitmap data created by step S11 are stored in hard disk 206 within association (step S14). In this embodiment, the second password stored in step S14 as the restriction information and the first password created by client PC 1 are the same.

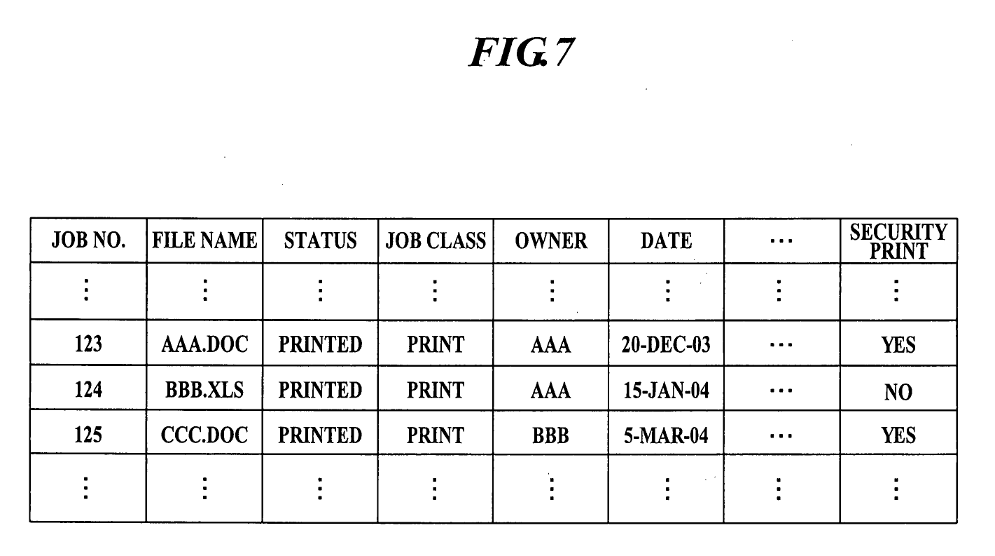

Information on bitmap data is stored in the hard disk 206 for every print job. One example of data composition of bitmap data table stored in hard disk 206 is described in FIG. 7. As described in FIG. 7, bitmap data table comprises of items such as job number (Job No.), file name (File Name), status of print job (Status), job class (Job Class), owner name (Owner Name), date (Date), information on presence of request for security print (Security Print), password (not shown), data size (not shown), and the like for each print job. When the printing is completed, Status in the bitmap data table displays “Printed”; when security printing is set, Security Print displays “Yes”.

Subsequently, along with bitmap data created by step S11, request for post processing (such as punching and stapling) set by the printer driver of client PC 1, information on presence of request for security printing, and password as restriction information are sent to printer 3 as the print data (step S15).

When it is determined that security printing is not set in step S12 (step S12; NO), bitmap data created by step S11 is stored in hard disk 206 (step S14), and along with the bitmap data, request for post processing set by the printer driver of client PC 1 and information on presence of request for security print are sent to printer 3 as the print data (step S15). When security printing is not set, the Security Print item in bitmap data table of FIG. 7 is displayed “No”.

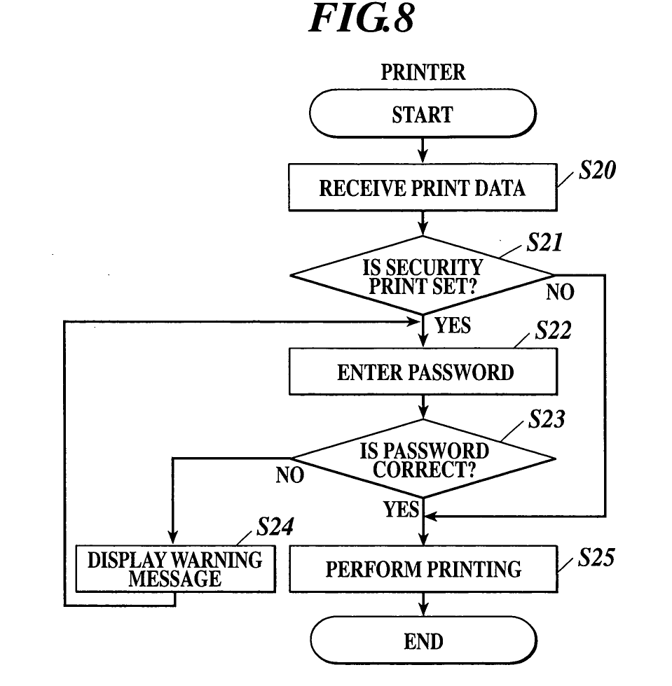

Next, the processing conducted at printer 3 is described referring to the flowchart FIG. 8.

When printer 3 receives print data from printer control unit 2 (step S20), determination on whether security printing is set or not is made (step S21). In step S21, if it is determined that security printing is not set (step S21; NO), print processing is conducted in accordance with the print data received by step S20 (step S25).

In step S21, if it is determined that security printing is set (step S21; YES), password input dialog is displayed on the operation panel unit 304, and promotes to enter the password. When password is entered in the password input dialog (step S22), verification of password is conducted by verifying (or comparing) the entered password and the password contained in the print data (step S23).

In step S23, if the entered password is determined as incorrect (step S23; NO), a warning message is displayed on the operation panel unit 304 (step S24), and returns to step S22, promoting to enter the password again. In step S23, if the entered password is determined as correct (step S23; YES), print processing is conducted in accordance with the print data received by step S20 (step S25).

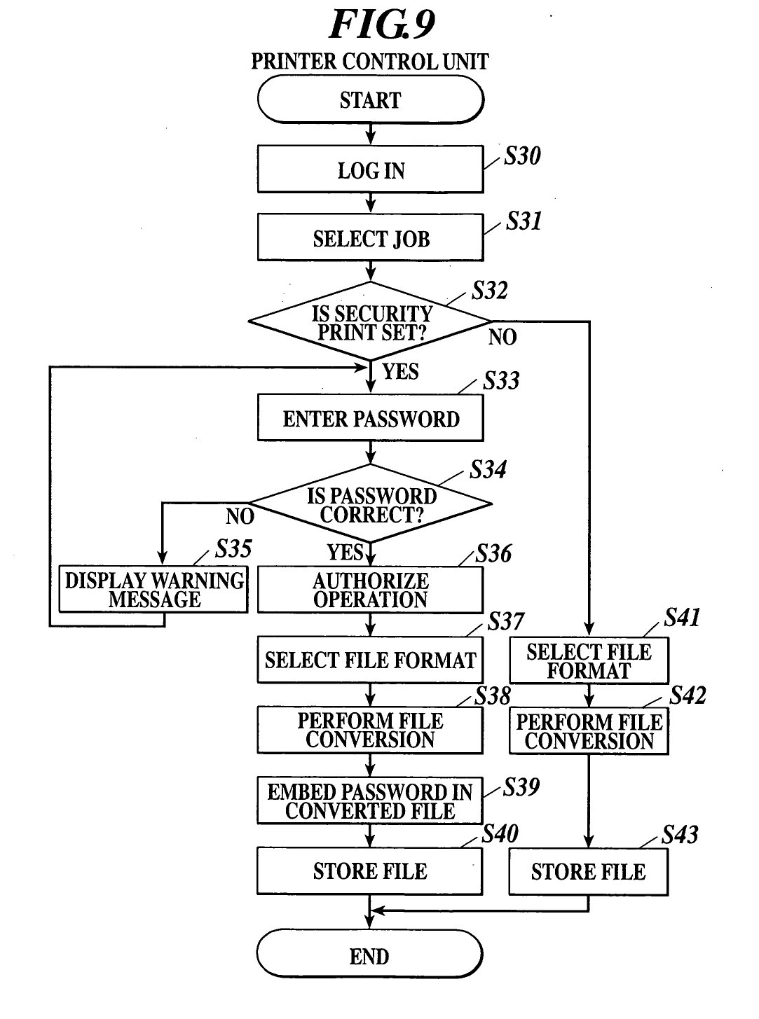

Next, the reuse processing of bitmap data stored in printer control unit 2 is described referring to the flowchart FIG. 9.

Bitmap data stored in printer control unit 2 can be reused by remote processing from client PC 1 through communication network N, however, FIG. 9 describes an example for processing reuse of bitmap data by print control unit 2. Additionally, as for the content of reuse of bitmap data, re-print, re-editing of image, converting to other file forms (such as conversion to PDF file), and the like can be mentioned, however, description on example for converting to other file form is given in this embodiment.

First, the utility application loaded in printer control unit 2 is started, and a user authentication screen is displayed on the display unit 207. Next, user authentication is conducted by log-in procedure in the user authentication screen. Following, the list of completed print job is displayed on the display unit 207, and from the print job list, the print job subject to reuse is selected by operating operation unit 208 (step S31).

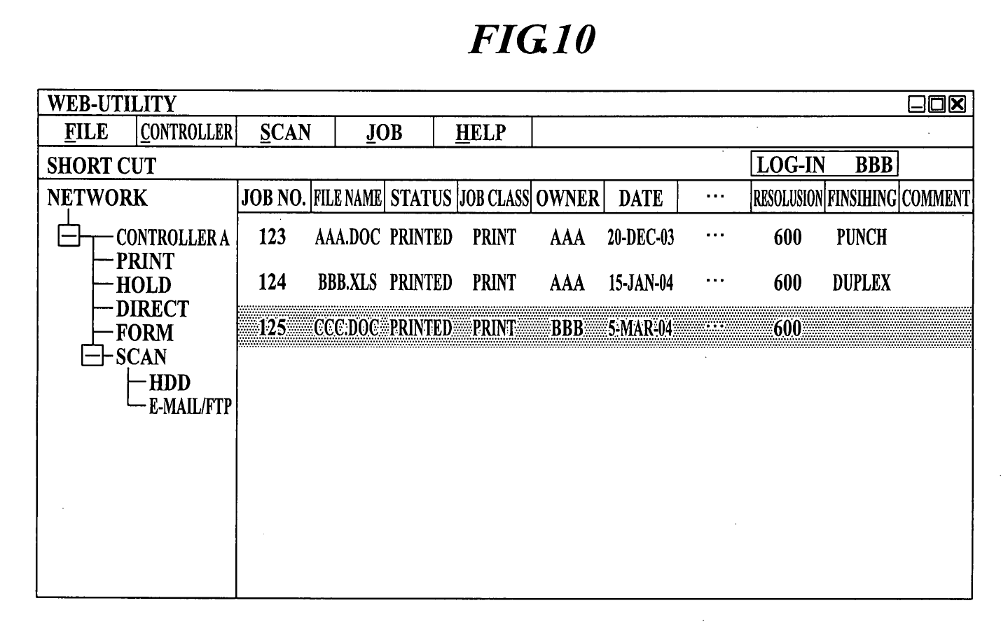

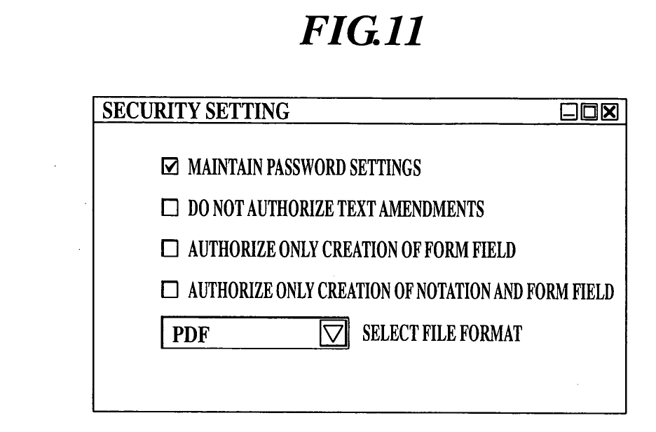

FIG. 10 shows an example of job list displayed on the display unit 207. The displayed print job are the jobs whose Status item is “Printed”,among the print job in the bitmap data table (refer to FIG. 7) stored in hard disk 206. In FIG. 10, an example for a case when a print job with File Name “ccc.doc” and Owner Name “BBB” is selected as the subject of reuse.

When the print job is selected, determination is made on whether selected print job was outputted by security printing or not (step S32). In step S32, if it is determined that the selected print job was not outputted by security printing (step S32; NO), a screen to select a file form is displayed on the display unit 207, and by the operation from the operation unit 208, the file form into which the bitmap data is to be converted is selected (step S41). Subsequently, the bitmap data is converted into the file form selected in step S41 (step S42), the converted file is stored in the hard disk 206 (step S43), and the processing for this reuse is completed.

In step S32, if it is determined that the selected print job was outputted by security printing (step S32; YES), password input dialog is displayed on the display unit 207, and promotes to enter the password. When password is entered in the password in put dialog (step S33), determination on whether the entered password is correct or not is conducted by verifying the entered password and the password of the selected print job (step S34).

In step S34, if the entered password is determined as incorrect (step S34; NO), a warning message is displayed on the display unit 207 (step S35), and returns to step S33, promoting to enter the password again. In step S34, if the entered password is determined as correct (step S34; YES), operation of the bitmap data of the print job is authorized (step S36). The password required for manipulation is same with the password set by client PC 1 (first password).

Subsequently, a screen to select a file form is displayed on the display unit 207, and by the operation from the operation unit 208, the file form into which the bitmap data is to be converted is selected (step S37). Subsequently, the bitmap data is converted into the file form selected in step S37 (step S38), the password entered in step S33 is embedded into the converted file created by step S38, the file embedded with the password is stored in the hard disk 206 (step S40), and the processing for this reuse is completed.

If the bitmap data is converted into a PDF form, in step S39, for example, the password is embedded into the PDF file as below. In the below example, “private” corresponds to the password String.

0 obj
<<
/Filter/Standard private

As described above, by recording the password in the PDF file, password will be required when operating this PDF file, and maintaining the confidentiality of the PDF file is achieved.

Additionally, by using digital ID function of the PDF file, usage authorization can be applied. In this case, usage authorization setting dialog as described in FIG. 11 is displayed on the display unit 207 when conversion into PDF file is conducted. An operator can arbitrarily select the authorization among plurality of items shown in the usage authorization dialog.

The set information from the usage authorization setting dialog input of FIG. 11 is stored in the PDF file as below.

...Reference [<</Type/SigRef/TransformMethod/DocMDP/
TranformParams<<Type/TransformParams/PX/V/1.2>>/...

Here, “PX” (X=1, 2, 3) is an identifier showing the usage authorization. In case of PDF, each “PX” stands for the following meanings.

P1: Do not authorize text amendments;

P2: Authorize only creation of form field;

P3: Authorize only creation of notation and form field.

In this case, form field is a place to input values within the form. The usage authorization “Authorize only creation of form field” is valid when PDL data was converted into PDF file directly, not via bitmap data. Moreover, as for the items to show the usage authorization in the usage authorization setting dialog, other than the items described in FIG. 11, for example, “Do not authorize color amendments”, “Do not authorize printing”, and the like can be included.

As described above, according to this embodiment of printing system 10, by reflecting the security information set by the client PC 1 to the rasterized image data (bitmap data), the confidentiality of the image data can be maintained even in the case where image data is converted into other file forms (such as PDF file) from the bitmap data is used (for example, when used within the function of Scan to E-mail).

Additionally, by using the same password as the password (first password) set in the security printing when operating the bitmap data or using data converted into other file forms, the workflow of the operator can be simplified.

The present application is based on the entire disclosure, including the specification, claims, drawings, and abstract, of Japanese Patent Application No. 2005-186601 filed with Japan Patent Office on Jun. 27, 2005.

What is claimed is:

1. An image forming apparatus comprising:
a receiving unit to receive PDL data;
an image operating unit to create bitmap data based on the PDL data;
a memory unit to store the bitmap data; and
a control unit to create a restriction information for reuse of the bitmap data, and to associate the restriction information with the bitmap data in reference to a first password, when the PDL data contains the first password.

2. The image forming apparatus of claim 1, wherein the control unit stores the restriction information with association to the bitmap data into the memory unit.

3. The image forming apparatus of claim 1, wherein the restriction information is a second password created from the first password.

4. The image forming apparatus of claim 3, wherein the control unit uses the identical password to the first password for the second password.

5. The image forming apparatus of claim 1, wherein the control unit determines whether to authorize the reuse of the bitmap data by an operator by referring to the restriction information.

6. The image forming apparatus of claim 5, wherein the apparatus comprises a processing unit to receive input by the operator, and
the control unit determines whether to authorize or not the reuse of bitmap data by verifying the information input from the processing unit with the restriction information.

7. An image operating apparatus for reusing bitmap data created when outputting a printing job that requires a first password, comprising:
an operation unit to receive input from an operator; and
a control unit to determine whether to authorize or not reuse of the bitmap data by an operator by verifying an information input from the operation unit with a restriction information for the reuse of the bitmap data created from the first password.

8. The image operating apparatus of claim 7, wherein the restriction information is a second password created from the first password.

9. The image operating apparatus of claim 8, wherein the second password is identical to the first password.

10. The image operating apparatus of claim 7, wherein the control unit sends information to promote a selection on whether or not apply the restriction information on the data file after operation, after authorization of operating the bitmap data to the operator.

11. The image operating apparatus of claim 10, wherein the image operating apparatus comprises a display unit to display various kinds of information, and the control unit makes the display unit display the information to promote the selection.
